(19) United States
(12) Patent Application Publication
(10) Pub. No.: US 2010/0288084 A1
(43) Pub. Date: Nov. 18, 2010

(54) Metric-inch wrench

(76) Inventors: Christopher Bullard Bullard, LILLINGTON, NC (US); Robby Britt Britt, Lillington, NC (US)

Correspondence Address: CHRISTOPHER BULLARD, HARNETT CORRECTIONAL INST., LILLINGTON, NC, 27546, US

(21) Appl. No.: 12/454,025

(22) Filed: May 12, 2009

(51) Int. Cl. B25B 13/02

(52) U.S. Cl. 81/125.1

(57) ABSTRACT

The abstract of this invention is simply that our invention has both metric and standard units of measurements on the same wrench. Thus metric units on one end and standard units on the other. Or any combanition that a manufacture desires to make, thus the consumer does not need to purchase two different sets of wrenches.

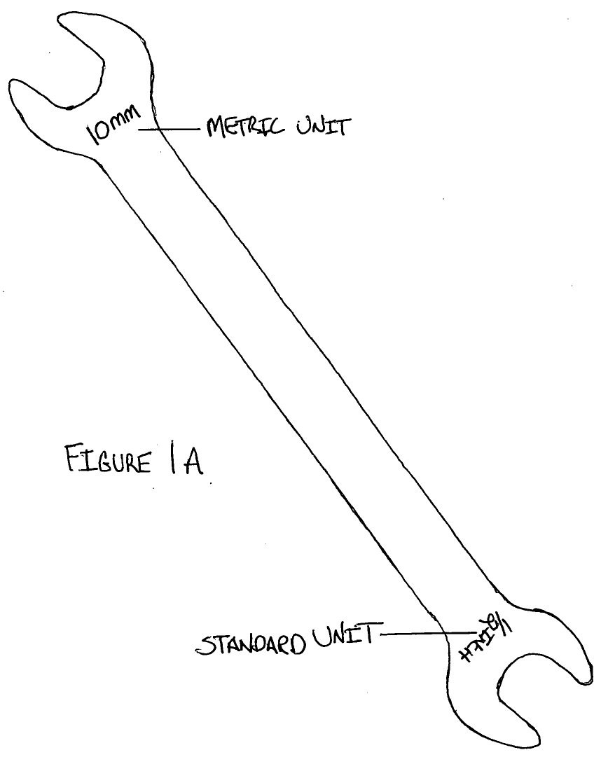

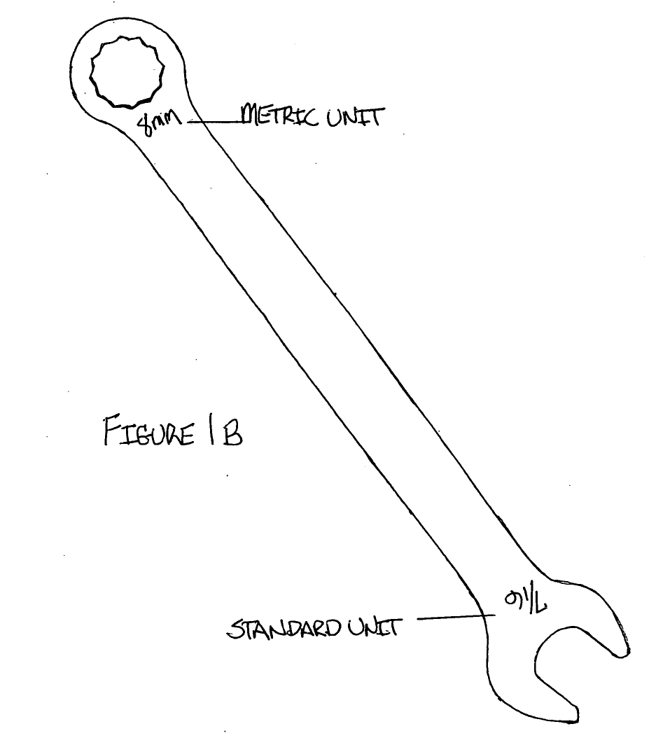

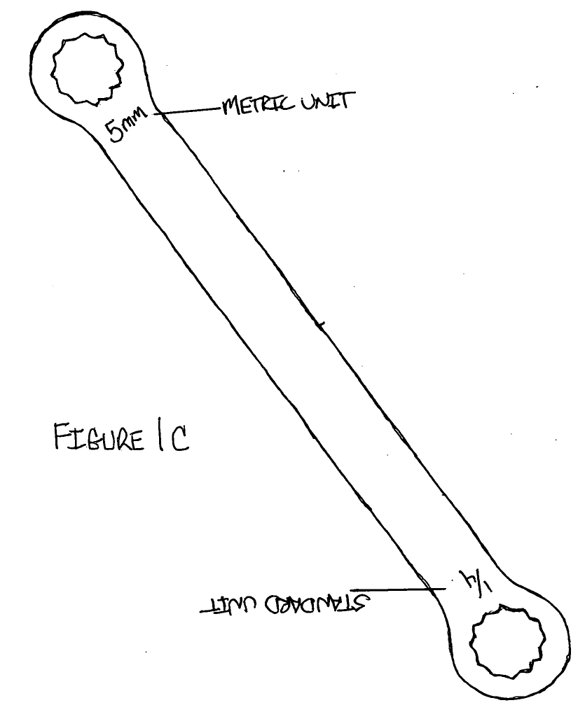

The invention we are applying for is a wrench. The standard wrench of today is normally. made by pouring liquid steel into a mold of various sizes. In order to obtain the proper sizes for the type of wrench being produced. “IE ½ inch, ¾ inch, 5 mm, and 10 mm’ then after the mold has cooled removing the wrench and polishing.

Using the finished product is simple, you choose the correct size wrench for the fastener you are trying to install or remove and then turn in the correct direction.

1. The invention we have applied for is a wrench that contains both standard and metric measures on any wrench. “IE ½ on an open end and 7 mm on the box end. The use of both metric and standard measures is the claim no matter what type of current wrench is made be it open end box end combination wrench.
